(19) United States
(12) Patent Application Publication
(10) Pub. No.: US 2025/0236801 A1
(43) Pub. Date: Jul. 24, 2025

(54) SYNGAS CLEANING AND SOOT RECOVERY

(71) Applicant: Sierra Energy Corporation, Davis, CA (US)

(72) Inventors: Johan Van Walsem, Davis, CA (US); Vineeth Valsan, Davis, CA (US); Paul Vergnani, Davis, CA (US); Sabias Lam, Davis, CA (US); Fred Cork, Davis, CA (US)

(21) Appl. No.: 18/840,852

(22) PCT Filed: Feb. 23, 2023
(86) PCT No.: PCT/US2023/013739

§ 371 Date: Aug. 22, 2024

Related U.S. Application Data
(60) Provisional application No. 63/313,800, filed on Feb. 25, 2022.

(51) Int. Cl. C10K 1/02; C02F 1/00; C02F 1/38; C02F 1/52; C02F 9/00; C02F 11/10; C02F 11/12; C02F 101/12; C02F 101/16; C02F 101/20; C02F 103/18; C10J 3/84; C10K 1/00; C10K 1/10; C10K 1/20

(52) U.S. Cl. CPC C10K 1/026; C02F 1/385; C02F 1/52; C02F 9/00; C02F 11/10; C02F 11/12; C10J 3/84; C10K 1/003; C10K 1/008; C10K 1/028; C10K 1/10; C10K 1/20; C02F 2001/007; C02F 2101/12; C02F 2101/16; C02F 2101/20; C02F 2103/18; C10J 2300/1603; C10J 2300/1807

(57) ABSTRACT

A method of removing impurities from black water associated with a gasifier includes adding a flocculant to the black water to create a black water and flocculant mixture, settling the black water and flocculant mixture in a gravity settling device to separate the black water and flocculant mixture into clarified water, a froth phase, and a heavy phase, the froth phase comprising soot, water, and air or gas, the heavy phase comprising soot and water, drawing off the clarified water from the settled black water and flocculant mixture, collecting a dilute slurry comprising the froth phase and the heavy phase, and phase separating the dilute slurry in a high-speed centrifuge to provide additional clarified water and a concentrated slurry, wherein the black water is obtained from wet gas scrubbing of syngas.

### CROSS REFERENCE TO RELATED APPLICATIONS

This application claims the benefit of priority to U.S. Provisional Patent Application No. 63/313,800 filed Feb. 25, 2022, which is hereby incorporated by reference, in its entirety for any and all purposes

### FIELD

This present technology relates to removal and recovery of particulate impurities such as soot and removal of gaseous contaminants, examples being halogenated acids, ammonia, and volatile heavy metals, from the synthesis gas (“syngas”) produced by a gasification reactor or gasifier, preferably a fixed bed, slagging, updraft oxygen gasifier; compositions produced therefrom; and processes including it. This technology further relates to the recovery of the soot and other particulate impurities collected in the wet gas scrubbing water in a form suitable for recycling to the gasifier as well as recovery of clarified water of a quality that is suitable to be re-used in wet gas scrubbing.

### BACKGROUND

Significant limitations have prevented the adoption of gasifiers for heterogeneous waste. Further, whereas particulate carbonaceous byproducts resulting from clean wood gasifiers may be land-applied; this is not the case for heterogeneous waste or treated waste wood that is classified as hazardous waste. There remains a significant need for processes to remove particulate impurities comprising carbonaceous and inorganic compounds such as soot from synthesis gas and/or scrubber water, such as that produced by a gasification process handling heterogeneous waste streams. There is also a need to remove a multitude of gaseous contaminants depending on the composition of the heterogeneous feedstock.

### SUMMARY

In one aspect, provided herein is a process of effectively removing soot from synthesis gas. In one embodiment, the soot is removed from the synthesis gas to a level, wherein the purified syngas, i.e., syngas from which the soot is removed, is suitable for a downstream conversion process. Some final products derived through these conversion processes comprise, without limitation, hydrogen (H₂), synthetic natural gas (CH₄), methanol (CH₃OH), ammonia (NH₃), liquid fuels, and gaseous feedstock for microbial fermentation to produce feed protein, biodegradable polymers, or alcohols.

In another aspect, provided herein is a process of effectively removing soot from synthesis gas wet scrubber water to a level suitable for recycling of the purified scrubber water, i.e., scrubber water from which the soot is removed, and/or recovering the soot from the scrubber water in a form suitable for recycling to a gasifier.

As used herein “effectively removing” refers to removing an amount, such as the amount of soot, from another component, such as syngas or wet scrubber water, such that the purified syngas or water is suitable for a desired purpose. As used herein, “purified” refers to a component, such as syngas, water such as wet scrubber water, or a mixture thereof, from which soot is effectively removed. As used herein, “removing” refers to removing at least a part of the soot or more, such as removing a substantial amount of the soot, substantially all of the soot, or effectively all of the soot.

In one embodiment, the synthesis gas is produced by a gasifier processing heterogeneous waste streams. In one embodiment, the gasifier is a fixed bed gasifier. In another embodiment, the gasifier is an oxygen blown gasifier. In another embodiment, the gasifier is a slagging gasifier.

In one embodiment, provided herein is a process of removing soot from the syngas, the process including a dry separation process. Illustrative dry separation processes comprise, but are not limited to, settling chambers, cyclones, ceramic filters, fabric filters, candle filters, impingement plates, and electrostatic precipitators. In one embodiment, the dry separation process removes greater than about 75%, preferably greater than about 80%, and most preferably greater than about 85% of the soot present in the syngas prior to separation, i.e., the syngas exiting the gasifier.

In one such embodiment, soot is removed from the syngas using dry separation methods at high temperatures. Soot collected via high temperature dry separation methods described can be recycled back to the gasifier with reduced contamination by condensable alkali salts, examples of which are K₂O, KCl, Na₂O, and NaCl. In one embodiment, the soot can be blended with the heterogeneous gasifier feed that increases the overall efficiency of the gasification process due to high carbon content of soot collected. Illustrative blenders useful in blending include, but are not limited to, ribbon blenders, pug mills, kneaders, or tumble blenders. In another embodiment, the soot can be injected into the gasifier pneumatically using a suitable lance or nozzle.

In another embodiment, provided herein is a process of removing soot remaining in semi-purified syngas, such as that obtained after dry separation, including wet syngas cleaning. If using a dry sorbent scrubbing process to remove acid gases from the synthesis gas stream, the wet scrubbing process would also remove spent sorbent from the gas by dissolving it in water. For example, a syngas can contact (e.g., flow through or otherwise be exposed to) a dry sorbent, where the dry sorbent can neutralize remaining halogenated acids in the syngas, such as syngas that has been separated from particulate soot (e.g., via a high-temperature cyclone or other device). Illustrative wet syngas cleaning methods comprise, but are not limited to, venturi scrubbers, scrubber towers equipped with plates, random packaging, or structured packaging, spray columns and wet electrostatic precipitation. In one embodiment, the wet syngas cleaning process removes residual soot to less than about 0.1 g/Nm³, and preferably less than about 0.05 g/Nm³, and most preferably less than about 0.01 g/Nm³, of the purified syngas. If using a dry sorbent process to remove acid gases, concentration of salts dissolved in the wet scrubber water will be allowed to reach a steady state through a ‘blowdown’ a known quantity of water and adding fresh water. In one embodiment, the blowdown water can then be sent to an evaporation pond or if the recovery of water is important, treated via process such as, but not limited to, reverse osmosis or crystallization followed by filtration, with the clean water produced being recycled back to the wet scrubbers. Spent or used dry sorbent can be removed from via a dry particle collection device. The dry particle collection device can operate above a dewpoint of syngas (e.g., syngas that has been separated from particulate soot, such as by a cyclone or other device).

The present technology is directed in part to a process separating soot present in dirty scrubber water, also commonly referred to as “black water,” thereby recovering clean water. In one embodiment, the recovered clean water is recycled to the wet gas cleaning process. In another embodiment, the separated soot is suitable for recycling to the gasifier.

In one embodiment, the process comprises separating the black water by a gravity separation device, thereby allowing clean water to be separated from soot as a clear middle layer. In one embodiment, the clean water is continuously withdrawn and recycled if needed. In another embodiment, the process further comprises recovering one or more of the heavy phase that settles to the bottom of the gravity separation device comprising wet soot; a froth phase comprising soot, water, and entrained gases (“froth”) that floats to the surface; and any combination of these two phases. Illustrative gravity separation devices comprise, but are not limited to, gravity settling chambers, high efficiency inclined plate gravity settlers and froth flotation tanks or columns. Without being bound by theory, it is contemplated that the high porosity, low particle density and hydrophobic nature of soot promote flotation and formation of a froth phase if entrained gases are present that preferentially attach to the soot given poor wettability of the soot.

In another embodiment, the process further comprises admixing a surface-active chemical (or a surface-active agent) into the black water prior to separation by the gravity separation device. In one embodiment, the surface-active chemical or agent is a surfactant. In another embodiment, the surfactant is an anionic surfactant. Non-limiting examples of such surfactants include Niaproof 08 and ColaWet DOSS 75. In another embodiment, the surfactant is a non-ionic surfactant. Non-limiting examples of such surfactants include DOW Ecosurf EH3, DOW Tergitol L61, Synperonic NCA 810, and Synperonic NCA 8300. In another embodiment, the surfactant is a cationic surfactant. In another embodiment, the surface-active agent is added in a range of about 0.1% to about 3% vol % (volume/volume), such as about 0.2 vol %, about 0.3 vol %, about 0.5 vol %, about 0.75 vol %, about 1 vol %, or about 2 vol %.

In another embodiment, the process further comprises admixing a flocculant into the black water prior to separating by the gravity separation device. In another embodiment, the flocculant is added in a range of 10-20 parts per million volume (ppmv), such as about 10 ppmv, 15 ppmv, or 20 ppmv. In another embodiment, a combination of the surface-active chemical and the flocculant (jointly referred to as a “chemical modifier”) is admixed into the black water prior to separation by the gravity separation device. Addition of surface-active chemicals results in a more effective and/or more rapid separation, resulting in lower equipment cost and higher clarity recycled water.

In another embodiment, the process further comprises collecting from the gravity separation device, a heavy phase from the bottom layer of the gravity separation device, comprising soot and water, and an upper froth phase layer from the upper layer of the gravity separation device, comprising soot, water and entrained air or gases, or any combination of the two. The combination of the two streams produces a dilute slurry comprising soot, water, and entrained air. In certain embodiments, the collecting is performed using one or more of nozzles, weirs, skimmers, and pumps. In one embodiment, the collected dilute slurry is fed continuously to a high-speed centrifuge. In certain embodiments, the centrifuge operates at a gravitational force or “g-force” of greater than about 6,000 to about 10,000 g-force. In certain embodiments, the high-speed centrifuge separates the dilute slurry into an underflow of concentrated slurry (e.g, wherein soot concentration in the concentrated slurry is higher by a factor of about 5 to 10 times that of the dilute slurry feed) and a clarified water from the overflow port of the high-speed centrifuge. The clarified water, in one embodiment, is recycled as clean scrubber water. In one embodiment, the high-speed centrifuge is a disc stack centrifuge. In another embodiment, the high-speed centrifuge is a decanter centrifuge. In another embodiment, a disc stack centrifuge is followed by a decanter centrifuge to further dewater the concentrated slurry collected by the disc stack centrifuge. In another embodiment, the black water from the wet scrubbers is fed directly to a high-speed centrifuge without prior processing in a gravity separation device.

In one embodiment, the only phase collected from the overflow port of the high-speed centrifuge, i.e. clarified water, is clear water or essentially clear water that is fully separated, i.e., for all practical purposes, from the soot. Entrained gases that are present in the froth phase from the gravity separation device that formed part of the dilute slurry fed to the centrifuge are vented from the centrifuge. It has surprisingly been found that, despite the froth phase being very persistent and difficult to separate in a high-speed swing tube laboratory centrifuge, processing in an industrial disc stack centrifuge resulted in clear water being produced without any solids carryover Without being bound by theory, it is contemplated after the observation that the interaction of the soot and entrained air within the froth with the closely spaced separating discs of the centrifuge, typically spaced about 1-2 mm apart, results in an effective degassing and wetting of the soot, thereby resulting in froth breakdown with soot reporting to the concentrated slurry and release of entrapped gases that are vented from the centrifuge.

In one embodiment, the concentrated slurry recovered from the centrifuge is recycled directly to the gasifier and blended with heterogeneous waste before being fed to the gasifier. Illustrative blenders useful in blending include, but are not limited to, ribbon blenders, pug mills, kneaders, or tumble blenders. In another embodiment, the concentrated slurry recovered from the centrifuge is recycled to the gasifier with a slurry pump and injected into the gasifier using a suitable lance or nozzle.

In another embodiment, the concentrated slurry recovered from the centrifuge is further dewatered comprising a suitable dewatering device. The dewatering improves the energy efficiency of the gasifier by reducing parasitic heat load required to heat and evaporate the additional water present in the concentrated slurry. Illustrative dewatering devices include, but are not limited to, rotary vacuum filter, vacuum belt filter, candle filter, filter press, decanter centrifuge, or thermal dryer. In one embodiment, the concentrated slurry is blended with heterogeneous waste and co-processed in a waste feed drier prior to being fed to the gasifier. In another embodiment, the concentrated slurry is dried separately using a dedicated dryer such as, but not limited to, a heated rotating drum dryer.

In another aspect, a method is provided for removing gaseous contaminants from the synthesis gas using a dry separation process. Dry gas cleaning processes have the distinct advantage over wet gas cleaning when halogenated acids, particularly HCl, are present in the syngas due to avoidance of condensing conditions where these compounds increase corrosion. In another embodiment, HCl is removed with a combination of dry and wet gas cleaning processes. HCl gas present in synthesis gas can be removed by reacting the gases with a solid sorbent such as alkali (Na, K) or alkaline earth (Ca) carbonates or oxides at medium to high temperatures (200-850° C.). Examples of sorbents include, but are not limited to, sodium bicarbonate or the minerals trona, nahcolite, shortite or dawsonite.

In one embodiment, the sorbent is injected directly into the gas stream or reacted with the gas stream in a fluidized bed. The reaction produces salts that can then be removed using wet or dry separation methods including, but not limited to, high-temperature candle filters, baghouse filters, high-temperature cyclone separators, venturi scrubbers, scrubber towers equipped with plates, random packaging or structured packaging, spray columns and wet electrostatic precipitation. Final concentration of HCl in syngas is reduced to 5 ppm or less; preferably under 1 ppm. In another embodiment, the synthesis gas can be passed through a fixed bed of sorbents pellets where spent sorbent is removed and replaced with fresh sorbent continuously or as a batch process.

These and other embodiments can be applied for the general purpose of converting multiple different waste streams into clean syngas, wherein soot is separated from the syngas and recovered from the black water and recycled to the gasifier whilst simultaneously recovering clarified water that is recycled and reused for wet gas cleaning.

In another aspect, provided herein is a purified (also referred to as clean) or semi-purified syngas composition. In another aspect, provided herein is a purified water, such as scrubber water composition.

The clean syngas can be converted into multiple end-products. Without limitation, the foregoing illustrative products include hydrogen (H₂), synthetic natural gas (CH₄), methanol (CH₃OH), ammonia (NH₃), liquid fuels, and gaseous feedstock for microbial fermentation to produce feed protein, biodegradable polymers, or alcohols. In another embodiment, a CO₂ co-product having a purity greater than about 95%, and preferably greater than about 99.5%, is recovered from the purge, or tail, gas following conversion of syngas to products.

The following disclosure provides, inter alia, these and other aspects of the invention, and non-limiting examples of various embodiments of the invention.

### BRIEF DESCRIPTION OF DRAWINGS

FIG. 1 is a diagram of a dry gas cleaning process where soot generated in the gasifier and spent sorbent in solid form is removed from the gas stream using dry separation methods.

FIG. 2 is a diagram of a process flowsheet comprising a venturi scrubber and packed bed scrubber tower used for wet syngas scrubbing.

FIG. 3 is a diagram of a process flowsheet comprising a venturi scrubber and packed bed scrubber combined with a settling tank and centrifuge to recover soot in accordance with the various embodiments.

FIG. 4 is a picture of a measuring cylinder after 5 minutes of gravity separation of soot from wet gas scrubber water that can be applied in various examples.

FIG. 5 is a picture showing dilute slurry being fed to a disc stack centrifuge and resulting clarified water from the disc stack centrifuge used to separate the soot in accordance with various embodiments.

FIG. 6 is a picture of the venturi scrubber tank from the flowsheet depicted in FIG. 2 showing a thick layer of froth comprising soot, water, and entrained gases.

FIG. 7 is a picture of the venturi scrubber tank from the flowsheet depicted in FIG. 3 demonstrating effective elimination of froth when incorporating a settling tank and centrifuge for removal of soot in accordance with various embodiments.

FIG. 8 is a picture showing the impact of multiple different Baker Hughes flocculants selected to improve gravity solids separation of the soot and promoting their partitioning to the froth phase in accordance with various embodiments.

### DETAILED DESCRIPTION

In this specification and in the claims that follow, reference will be made to a number of terms that have the meanings below. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, and the like), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

“Black Water” refers to dirty water resulting from wet syngas cleaning unit operations designed specifically to remove particulate solids including, without limitation, venturi scrubbers, tower scrubbers, and wet electrostatic precipitators. The solids laden dirty scrubber water resulting from these unit operations are typically colored dark black due to the presence of suspended soot particles.

“Chemical Modifier” refers collectively to any combination of surfactants and/or flocculants selected for the purpose of enhancing the performance of the unit operations used for the separation of particulate solids from the black water (i.e. increasing the rate and/or quality). These unit operations include, without limitation, gravity separation, centrifugal separation, filtration, and flotation processes.

“Concentrated slurry” refers to the underflow collected by a high-speed centrifuge that processes the dilute slurry. Concentrated slurry comprises wetted soot and water with essentially no entrained air or gas. Soot in the concentrated slurry is typically concentrated by a factor of about 5 to 10 times relative to that present in the dilute slurry.

“Dilute slurry” refers to the combined heavy phase and froth phase collected respectively from the bottom and upper layer of a gravity separation device used to separate black water. The heavy phase comprises soot particles that settled to the bottom and water. The froth phase comprises soot, water and entrained gas or air with a combined density less than water resulting in the froth collecting in the upper layer. The dilute slurry comprises soot, water and entrained gas or air with a soot concentration of about 1 to about 10% by weight.

“Envelope Density” refers to the density of a porous solid particulate with the voids filled with air or gas. This density represents the weight of the particle contributed by the skeletal solids divided by the total envelope volume of the particle. As a non-limiting example, a solid particle with a skeletal density of 2.0 g/cm³ and a porosity of 50% will have an envelope density of 1.0 g/cm³ ignoring the minor contribution of air.

“Flocculant” refers to a substance that promotes the agglomeration of fine particles present in a dispersion or emulsion by reducing the repulsive forces between these particles, thereby promoting flocculation of the particles into larger agglomerates also known as flocs, which then floats to the surface (flotation) or settles to the bottom (sedimentation). The flocculant accelerates the rate of flotation or sedimentation and also the quality of separation of the particles from the liquid.

“Gasification” refers to gasifying coal, liquids, dust, and slurries and the term also includes waste gasification such as heterogeneous waste gasification. In lower temperature gasification (generally below about 1000° C.), dry ash is generated as a waste product. In higher temperature gasification, e.g., those performed by a slagging gasifier, these operate at temperatures in excess of the ash melting point (generally above about 1400° C.) and produce a molten slag that is typically quenched. A gasifier or a gasification reactor performs gasification. Gasifiers include fixed bed, fluid bed, circulating fluid bed and entrained flow gasifiers.

“Heterogeneous waste” refers to without limitation municipal solid waste (“MSW”), wood, agricultural waste, coal, petcoke, or hydrocarbon waste streams with variable particle morphology such as in a size range from 6 mm to 100 mm outside the range that can be handled by fluid bed, entrained flow or existing fixed bed gasification processes. The heterogeneous waste feed to the gasifier includes any mixture of the above waste streams whether fed to the gasifier in a single blended stream or as separate feed streams, either sequentially or via separate feeders into the gasifier.

“Skeletal Density” refers to the true density of the solid phase within a porous particle. This density is equivalent to the density of a particle with zero porosity.

“Soot” refers to solid carbonaceous particulates resulting from partial oxidation of hydrocarbons and tar. Soot generated from a gasification process comprises mostly carbonaceous material of greater than about 80% to 90% by weight and inorganic ash components typically less than about 10% to 20% by weight.

“Surfactant” refers to any surface-active chemical used to modify the surface chemistry and interaction between different phases that may comprise solids, liquids and gases and any combination of these. Non-limiting examples include detergents, foaming agents, emulsifiers, dispersing aids and wetting agents.

“Synthesis gas,” or “syngas,” is the gaseous product of the gasification of heterogeneous waste which is comprised of CO, H₂, CO₂, H₂O, CH₄, C2 and higher hydrocarbons including condensable hydrocarbons heavier than C3 compounds (i.e. tar) and solids carried over with the syngas comprising carbonaceous soot and mineral ash components.

“Tar” refers to condensable hydrocarbons having greater than 3 carbon atoms (C3) including oxygenated compounds formed during gasification, e.g. and without limitation, from heterogeneous waste gasification.

### Descriptive Embodiments

In one aspect, provided herein is a method or process of removing impurities from black water (e.g., dirty scrubber water) associated with a gasifier. The method can include adding a flocculant to the black water to create a black water and flocculant mixture; settling the black water and flocculant mixture in a gravity settling device to separate the black water and flocculant mixture into clarified water, a froth phase, and a heavy phase. The froth phase can include soot, water and air or gas. The heavy phase can include soot and water. The method can include separating and/or drawing off the clarified water from the settled black water and flocculant mixture. The method can include collecting a dilute slurry comprising the froth phase and the heavy phase. The method can include phase separating a dilute slurry. The dilute slurry can include the froth phase and the heavy phase. The method can include phase separating the dilute slurry in a high-speed centrifuge to provide additional clarified water and a concentrated slurry; wherein the black water is obtained from wet gas scrubbing of syngas. The black water can include soot or gaseous contaminants, such as halogenated acids, ammonia, or volatile heavy metals, for example.

In one embodiment, the method or process further comprises recycling the clarified water for re-use as wet gas scrubbing water. In another embodiment, the method further comprises recycling the concentrated slurry to a gasifier producing the syngas. In another embodiment, the concentrated slurry is recycled via a liquid injection nozzle. In another embodiment, the concentrated slurry is recycled comprising mixing it with solid feed material prior to being recycled to the gasifier. In another embodiment, the method further comprises dewatering the concentrated slurry in a filter, membrane, centrifuge, or dryer prior to recycling to the gasifier. In another embodiment, the method further comprises adding a surface-active agent to the wet gas scrubbing device. In another embodiment, the clarified water produced by the high-speed centrifuge is substantially free of entrained gases, solids, or froth. In another embodiment, the wet gas scrubbing comprises scrubbing the syngas with one or more of a venturi scrubber, a column scrubber, and a supplementary solids separation device. In another embodiment, the supplementary solids separation device is a wet electrostatic precipitator. The supplementary solids separation device removes trace particulate impurities. In another embodiment, the phase separating is performed in absence of a surfactant.

In one embodiment, the syngas is produced by a gasifier that gasifies a heterogeneous waste. In one embodiment, the gasifier comprises a tar destruction zone (“polisher section”) preferably integral with the gasifier located in the upper zone of the gasifier. In one embodiment, the tar destruction zone comprises one or multiple burners arranged around the periphery. In one embodiment, the one or multiple burners are arranged at multiple heights within the tar destruction zone. In certain embodiments, the burners operate above stoichiometric oxygen levels. Stoichiometric oxygen refers to the molar ratio of oxygen required to completely combust one mol of fuel to CO₂ and H₂O. As a non-limiting example, the stoichiometric O₂ requirement to combust one mol of a CₓH_{y} hydrocarbon is equal to (x+y/4) mol O₂.

In another embodiment, the heterogeneous waste material requires no, or substantially no, pre-processing, limited to removal of large items that cannot be shredded, metal, rocks, and hazardous materials such as explosives. In another embodiment, the heterogeneous waste material requires only basic shredding to a preferred size range of about ¼″ to about 2″ (i.e. about 6 mm to about 50 mm). In another embodiment, the heterogeneous waste material requires drying only if the moisture content is greater than about 20% by weight.

In another embodiment, the tar destruction zone has a residence time of at least about 2 seconds and most preferably about 5 seconds to achieve effective tar destruction. As used herein, effective tar destruction refers to the destruction of all, or substantially all, of the tar and its simultaneous conversion to additional non-condensable syngas and tar-free residual particulate soot, so that the syngas can be further processed in heat recovery and solids removal unit operations downstream of the gasifier without fouling from residual tar condensing as the syngas temperature is reduced.

In another embodiment, the tar destruction zone temperature is at least about 2000° F. (1093° C.). In another embodiment, the tar destruction zone temperature is greater than about 2200° F. (1204° C.).

In one embodiment, the gasifier does not comprise a plasma torch. In another embodiment, the gasifier does not comprise a bed permeability additive. An illustrative example of a bed permeability additive is narrow size distribution coke. Plasma torches introduce cost and complexity and require very high parasitic electrical load that negatively affects the overall energy efficiency of the gasifier. Bed permeability agents such as coal that have high crush strength are high cost and sourced from non-renewable resources resulting in elevated greenhouse gas emissions from the gasifier.

In another aspect, provided herein is a syngas composition also referred to simply as syngas, and such other compositions. In one embodiment, the syngas composition is provided by gasifying a heterogeneous waste. In one embodiment, the syngas composition exits the top of the polisher section of the gasifier. In another embodiment, the syngas composition has a tar content less than about 5 g/Nm³. In another embodiment, the syngas composition has a tar content of preferably less than about 2 g/Nm³. In another embodiment, the syngas composition has a soot content less than about 10 g/Nm³, and preferably less than about 5 g/Nm³.

In another embodiment, the syngas composition is free or substantially free of soot. In another embodiment, soot is removed from the syngas produced by the gasifier using dry separation methods such as, but not limited to, cyclones, ceramic baghouses, electrostatic precipitators, or candle filters, at high temperatures. In another embodiment, soot is removed by a high temperature cyclone prior to cooling the syngas below about 900° C. to recover a soot free of condensed alkali salts, which is recycled to the feed of the gasifier. The cyclone can be a cylindrical or conical settling chamber that can cause gas (e.g., syngas) to flow in a helical or circular manner within the chamber. Particles (e.g., soot) within the gas can move to an outer wall within the chamber of the cyclone via centrifugal force and can be collected at a bottom of the cyclone. For example, the centrifugal force created within the cyclone chamber can cause solid particulate matter within a gas to separate from the gas so that gas can exit the cyclone (e.g., out a center or top of the cyclone) substantially without particulate matter. For example, particulate soot can be removed from a syngas by dry separating the particulate soot from the syngas with a high-temperature cyclone. The removed particulate soot can be provided (e.g., recycled) to a gasifier, for example. By removing the soot at high temperatures, any alkali oxides will remain a vapor in the gas stream carried over from the gasifier rather than deposit out and contaminate the soot being separated or foul the lines and equipment. The minimum temperature for this separation will depend on the composition of the alkali oxides being carried over from the gasifier (which can include Na₂O and K₂O) and these compounds' vapor pressures at the temperatures in question.

Soot collected via dry separation methods described can be recycled back to the gasifier. In one embodiment, the soot can be blended with the heterogeneous gasifier feed that increases the overall efficiency of the gasification process due to high carbon content of soot collected. Illustrative blenders useful in blending include, but are not limited to, ribbon blenders, pug mills, kneaders, or tumble blenders. In another embodiment, the soot can be injected into the gasifier pneumatically using a suitable lance or nozzle.

In some embodiments, soot in the syngas is substantially removed from the syngas using wet gas scrubbing to capture the soot in the scrubber water or black water. In one embodiment, the black water is dewatered in a filter, centrifuge, hydrocyclone, flotation cell, or other suitable device, providing a concentrated slurry, comprising soot and residual water, that is recycled to the solids feeder of the gasifier. In another embodiment, the concentrated slurry is circulated back to the gasifier and injected into the gasifier via one or more lances via liquid injection nozzles.

In one embodiment, the black water produced during wet gas scrubbing is conditioned or mixed with a surfactant and directed to a gravity settling chamber, high efficiency inclined plate gravity settler, froth flotation tank or other gravity solids separation device to separate the soot into a heavy phase that sinks to the bottom, an upper froth phase that floats to the upper surface or a combination of both phases, and optionally further recovers at least a portion of the water contained in the black water as a clarified water layer substantially free of soot or other particulate solids. In another embodiment, the surfactant is a wetting agent selected to promote wetting of the suspended particulates and subsequent settling of the soot. As used herein, a wetting agent reduces the surface tension between the solid surface and liquid to promote wetting.

In one embodiment, the black water is conditioned with a flocculant selected to promote gravity separation via aggregation of particulates and soot particles resulting in faster settling into the heavy phase and/or flotation into an upper froth phase.

In one embodiment, the dilute slurry separated from the black water in a gravity separation device is collected from the upper and bottom layers or any combination of these layers and further processed in a high-speed centrifuge to separate at least a portion of the water contained in the slurry as clarified water that is collected from the high-speed centrifuge while simultaneously concentrating (i.e. increasing) the soot content of the slurry that is collected as a concentrated slurry from the underflow of the high-speed centrifuge. In one embodiment, the centrifuge is a disc stack centrifuge.

In one embodiment, the black water from the wet scrubbers is sent directly to the high-speed centrifuge that recovers from the black water clarified water that is at least substantially free of solids while simultaneously collecting the soot as an underflow in the form of a concentrated slurry. In another embodiment, this clarified water is recycled back for use in the wet scrubbers. In another embodiment, the concentrated slurry is recycled directly back to the gasifier. In another embodiment, the concentrated slurry is further dewatered using a belt filter, filter press, drum dryer, or other suitable device before being recycled back to the gasifier.

In another aspect, a method is provided removing gaseous contaminants (such as, e.g. hydrochloric acid) from the synthesis gas using a dry separation process. Dry gas cleaning processes have the distinct advantage over wet gas cleaning when HCl is present in the syngas due to the reduced corrosion of metal components in downstream equipment and piping. Even when quickly neutralized in wet scrubbers using bases such as NaOH or Na₂CO₃, the Cl⁻ ions are known to play a significant role in pitting corrosion reactions of ferrous metals. They may be adsorbed or penetrate easily through the passive oxide layers damaging their integrity and accelerating electrochemical reactions. There are also strict limits on the concentration of HCl gas sent to downstream processes such as Fuel Cells, internal combustion engines, gas turbines, ammonia production, methanol synthesis, and the like.

HCl gas present in synthesis gas can be removed by reacting the gases with a solid sorbent such as alkali (Na, K) or alkaline earth (Ca) carbonates or oxides at medium to high temperatures (200-850° C.). Examples of sorbents include, but are not limited to, sodium bicarbonate or the minerals trona, nahcolite, shortite, dawsonite, and the like. Depending on the final choice of sorbent used, some typical reactions of sorbents with HCl are:

Na₂CO₃+2HCL→2NaCl+H₂O+CO₂

NaHCO₃+HCl→NaCl+H₂O+CO₂

K₂CO₃+2HCl→2KCl+H₂O+CO₂

CaCO₃+2HCl→CaCl₂+H₂O+CO₂

CaO+2HCl→CaCl₂+H₂O

In some embodiments, the sorbent is injected directly into the gas stream or reacted with the gas stream in a fluidized bed. The reaction produces salts that can then be removed using wet or dry separation methods including, but not limited to, high-temperature candle filters, baghouse filters, high-temperature cyclone separators, venturi scrubbers, scrubber towers equipped with plates, random packaging or structured packaging and spray columns. In another embodiment, the synthesis gas can be passed through a fixed bed of sorbents pellets where spent sorbent is removed and replaced with fresh sorbent continuously or as a batch process. In another embodiment, the gas stream post injection of sorbent is cooled to a temperature below which the spent sorbent to be separated does not have significant vapor pressure allowing for more efficient separation using dry separation methods such as, but not limited to, cyclones, baghouses, electrostatic precipitators or candle filters.

In one embodiment, the soot and HCl free syngas is further converted to hydrogen, synthetic natural gas, methanol, ammonia, liquid fuels, or other gaseous feedstock for microbial fermentation to produce feed protein, biodegradable polymers, or alcohols, comprising or produced from the syngas composition provided herein (collectively “end-products”).

In one embodiment, provided herein, a hydrogen end-product with purity greater than about 99.9% and preferably greater than about 99.99% is recovered from the syngas.

In one embodiment, provided herein, a CO₂ co-product with purity greater than about 95%, and preferably greater than about 99.5%, is recovered from the purge or tail gas remaining after the conversion of syngas to end-products.

Certain non-limiting advantages of the technologies provided herein include, one or both of, removing all or substantially all the soot from the syngas, in part by wet syngas cleaning, and recapturing the soot in the wet gas scrubber water or black water. Black water is challenging to recycle and clarify given the extremely hydrophobic nature of soot particles that promote formation of a very persistent froth phase that can damage equipment such as pumps, amongst other challenges. A significant advantage of the technology and methods provided herein is the ability to efficiently separate the black water into a) clarified water, substantially free of solids that can be recycled as scrubber water and b) a partially dewatered concentrated slurry that can be recycled to the gasifier, avoiding generation of a waste stream and increasing the overall end-product yield.

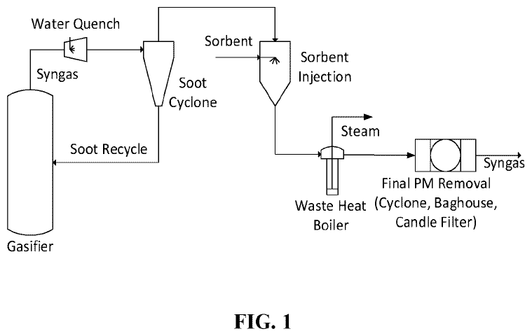

FIG. 1 illustrates a typical dry gas cleaning flowsheet and equipment used in certain embodiments to remove soot and HCl from syngas generated by a gasifier. In a preferred embodiment, the gasifier, equipped with an integrated tar destruction zone or a separate tar destruction unit operation converts a carbon-containing feedstock including, but not limited to, municipal solid waste (“MSW”), wood, agricultural waste, coal, petcoke, or hydrocarbon to synthesis gas (“syngas”), substantially free of tar, comprised of CO, H₂, CO₂, H₂O, CH₄, and C₂ and higher non-condensable hydrocarbons as well as particulate solids carried over with the syngas comprising carbonaceous soot and inorganic ash components.

In one embodiment, syngas from the gasifier is quenched to approximately 800° C. At this temperature, there will be no significant deposition of alkali oxides being carried over from the gasifier. This is also close to the upper temperature limit of some of the sorbents proposed before they decompose. Soot in the syngas is separated at this high temperature using dry separation methods such as, but not limited to, cyclones, ceramic filters, and the like. In one embodiment, the soot is then recycled back to the gasifier using pneumatic lances or mixed in with the gasifier feedstock to increase overall gasifier efficiency. After this step, the sorbent of choice is contacted with the syngas through, but not limited to, direct injection, fluidized bed or a fixed bed. In FIG. 1, direct injection is employed.

In one embodiment, as shown in FIG. 1, the gas is then cooled using a waste heat boiler that produces usable steam for the rest of the plant. At a minimum, the temperature of the gas is brought down low enough such that the salts formed through the reaction of sorbent with HCl gas does not have significant vapor pressure. In another embodiment, this is achieved by quenching with water instead of using a waste heat boiler.

In one embodiment, shown in FIG. 1, the salts generated by the sorbent reactions are removed via dry gas cleaning steps such as, but not limited to, cyclones, baghouses or candle filters. The syngas, now substantially free of soot and HCl gas, is now sent for further processing or conversion to end products.

In another embodiment, instead of using dry gas separation for removal of the residual salts, wet gas cleaning is employed instead.

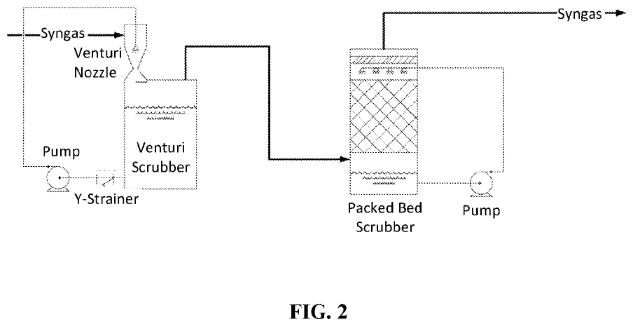

FIG. 2 illustrates a typical flowsheet and equipment used in certain embodiments during wet gas scrubbing to remove residual soot remaining in the syngas following upstream syngas heat recovery and dry particulate solids removal operations. The production and dry gas processing of syngas from the gasifier prior to wet gas scrubbing is provided. In a preferred embodiment, the gasifier equipped with an integrated tar destruction zone or a separate tar destruction unit operation converts a carbon-containing feedstock including, but not limited to, municipal solid waste (“MSW”), wood, agricultural waste, coal, petcoke, or hydrocarbon to synthesis gas (“syngas”), substantially free of tar, comprised of CO, H₂, CO₂, H₂O, CH₄, and C₂ and higher non-condensable hydrocarbons as well as particulate solids carried over with the syngas comprising carbonaceous soot and inorganic ash components.

In one embodiment the syngas exiting the gasifier is partially quenched with water to a temperature of less than about 800 to about 850° C. before heat recovery in a waste heat recovery boiler to produce steam while further cooling the syngas to temperature less than about 200 to about 250° C. Without being bound by theory, quenching the syngas prior to entering heat recovery equipment can significantly reduce fouling of heat exchange surfaces by reducing the stickiness of ash encountered at higher temperatures. In another embodiment, the syngas is quenched using water injection to a temperature of about 200 to about 250° C. without any heat recovery. After heat recovery or quenching, a significant fraction of about 75% to about 85% of the soot and particulate matter is removed from the syngas employing dry syngas particulate removal methods including, but not limited to, high-temperature candle filters, baghouse filters, and high-temperature cyclone separators. The syngas is then further purified using wet gas scrubbing methods to remove residual particulate solids and water-soluble gaseous impurities, including without limitation HCl, HF and NH₃.

As depicted in FIG. 2, in certain embodiments, the syngas enters the Venturi Scrubber where it is contacted with a high scrubbing liquid to gas ratio. The Venturi Scrubber utilizes a large scrubbing water volume delivered by a circulating pump to a high-pressure nozzle located upstream of the Venturi Scrubber throat in a co-current flow pattern. As the gas enters the throat section, liquid droplets are sheared by the high relative velocity difference between the gas and liquid and further reduced in size. These small droplets have a large surface area per unit volume resulting in efficient collection of particulate impurities present in the syngas into the scrubber water. Water-soluble gaseous impurities including but not limited to HCl, HF and NH₃ are also significantly removed from the syngas with about 80% to 95% of these impurities being dissolved in the scrubber water.

In other embodiments, the gas is then directed to the Packed Bed Scrubber where it is contacted with a countercurrent flow of water using multiple stages in a column equipped with multiple spray nozzles, multiple gas/liquid contacting plates, random packaging, structured packaging or other suitable gas/liquid contacting internal devices. In some embodiments the scrubber water is dosed with chemicals including, without limitation, surfactants, flocculants or pH adjusting chemicals such as sulfuric acid or sodium hydroxide or other suitable acids or bases, to further increase the efficiency of particulate and gaseous impurity removal to greater than about 95% and preferably greater than about 99%. The syngas exiting the wet gas scrubbing section of FIG. 2 is then further processed using well known techniques to remove additional trace impurities prior to further processing and conversion into products including, without limitation, hydrogen (H₂), synthetic natural gas (CH₄), methanol (CH₃OH), ammonia (NH₃), liquid fuels, and gaseous feedstock for microbial fermentation to produce feed protein, biodegradable polymers, or alcohols.

The flowsheet of FIG. 2 depicts embodiments including two circulation pumps, one each for the Venturi Scrubber and the Packed Bed Scrubber. As would be understood by those skilled in the art, the circulating water accumulates impurities that, over time, impede the efficient functioning of the equipment and desired separation of impurities from the syngas. The scrubber water, now laden with particulate soot, dissolved water-soluble gaseous impurities and mineral ash is commonly referred to as black water. To ensure continued satisfactory performance of the wet gas scrubbing equipment, a certain amount of the black water is purged and substituted with fresh make-up water. Removing the suspended soot from this purge stream is challenging given the small particle size as well as hydrophobic nature of soot particles. Discharging this stream as wastewater is further challenging due to the presence of toxic substances that may be present in the soot.

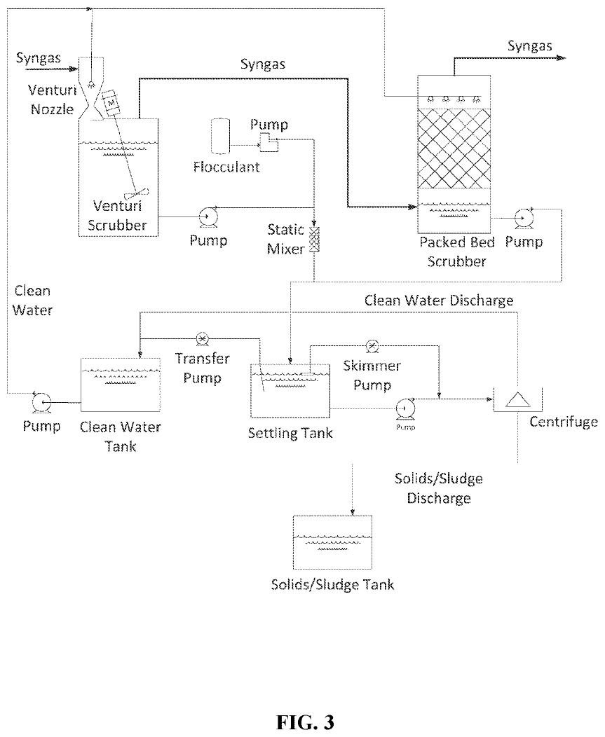

FIG. 3 is a schematic of an embodiment of a modified wet gas scrubbing process to address the challenges related to processing and reclaiming soot and clean water from the black water purge in accordance with various embodiments. As depicted in FIG. 3, the circulating black water is directed to the Settling Tank (an illustrative and non-limiting gravity separation device). The Venturi Scrubber is equipped with an agitator to ensure good suspension of the soot such that all the soot is transferred to the Settling Tank rather than accumulate in the Venturi Scrubber sump. In certain embodiments, a suitably selected chemical modifier such as a flocculant or surfactant is injected into the black water using the Static Mixer to ensure good dispersion prior to entering the settling tank. As used herein, a flocculant promotes the aggregation of fine suspended soot particles into larger aggregates to increase the rate and quality of separation between soot and clear water in the Settling Tank.

In some embodiments, the gravity-settling rate is increased such that substantially clear water separates from the soot containing froth and heavy phases in less than about 5 minutes and preferably less than about 1 minute in the 500 milliliter (“mL”) Measuring Cylinder test depicted in FIG. 4 as a non-limiting example. In one embodiment, a froth phase comprising soot, water, and air accumulates on the surface of the clarified water. In another embodiment, suspended soot settles into a heavy phase at the bottom of the clarified water. In some embodiments, both a froth and a heavy phase separate from the clarified water.

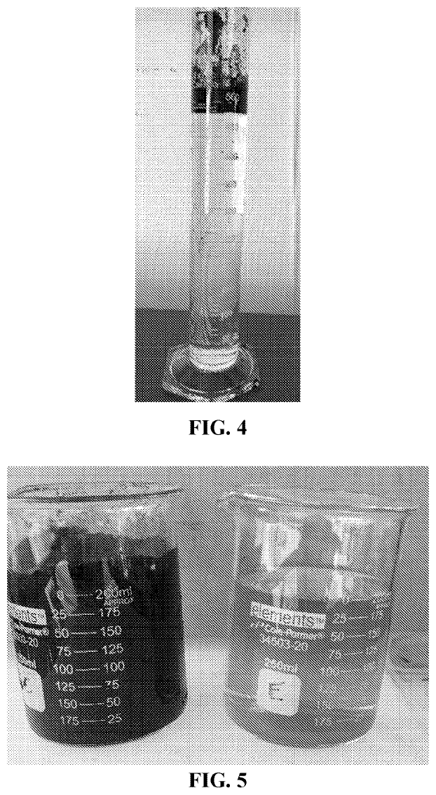

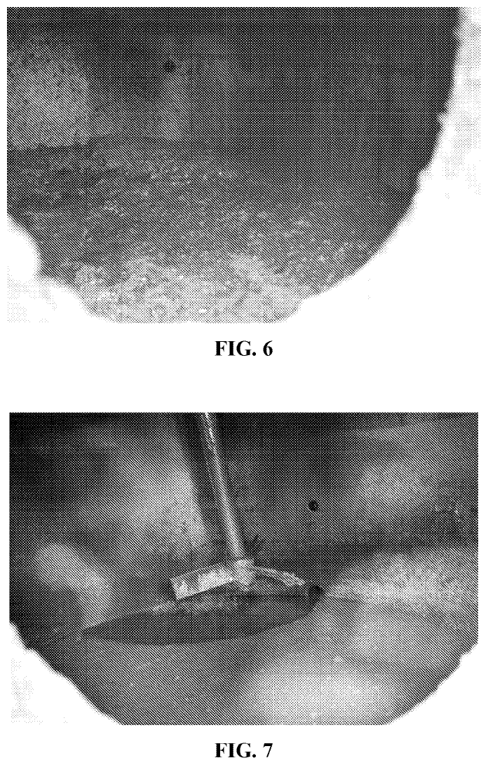

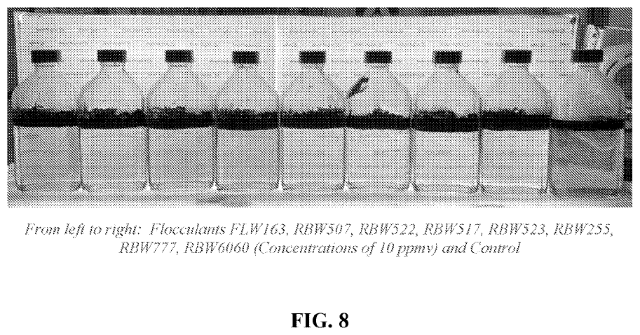

Clarified water is drawn from an intermediate layer using a suitable Transfer Pump and directed to the Clean Water Tank from where a pump is used to recycle reclaimed clean water to the Venturi Scrubber and Packed Bed Scrubber. The soot containing froth phase is collected from the upper layer of the clarified water in the Settling Tank using a suitable Skimmer Pump and combined with heavy phase that is withdrawn from the bottom layer of the Settling Tank. The combined froth phase and heavy phase stream produces a dilute slurry typically in the range of about 20-30% of the total volume processed in the Settling Tank. Therefore, the equivalent of about 70-80% of the black water volume fed to the Settling Tank is reclaimed as clarified water for re-use in wet gas scrubbing using simple gravity separation aided by the flocculant. The dilute slurry stream is then directed to a high-speed disc stack centrifuge that operates about 6,000-10,000 g-force. The Centrifuge separates the dilute slurry feed into an underflow concentrated slurry and an overflow clarified water substantially free of any solids or froth as depicted in FIG. 5 where the left-hand beaker is a picture of the dilute slurry feed to the centrifuge and the righthand picture being clarified water collected from the overflow of the Centrifuge. The concentrated slurry is typically less than about 5% by volume and preferably less than about 2% of the by volume of the dilute slurry fed to the Centrifuge. Therefore, more than about 95%-98% of the dilute slurry feed to the centrifuge can be reclaimed as clear water that is directed to the Clean Water Tank to be re-used in the wet gas scrubbing process. FIG. 6 and FIG. 7 are comparative pictures of the contents of the Venturi Scrubber sump for the base case flowsheet depicted in FIG. 2 and the modified flowsheet of FIG. 3, in accordance with various embodiments. As is evident, the significant froth phase that impedes operational stability of wet gas scrubbing in FIG. 6 is substantially eliminated in FIG. 7 with only a thin layer of hydrophobic solids without any froth present on the surface.

In one embodiment, the concentrated slurry stream is recycled to the gasifier by blending with a fraction of the heterogeneous waste in a suitable mixer, including without limitation, a solids blender or pug mill, prior to being fed to the gasifier. In another embodiment, the concentrated slurry is recycled to the gasifier using a slurry pump and modified lance to inject the slurry directly into the bed of material in the gasifier. In another embodiment, the concentrated slurry is further dewatered using suitable equipment including, without limitation, a belt filter, a vacuum drum filter, filter press, zwitterionic crossflow membrane filter, decanter centrifuge, or a drum dryer. A zwitterionic membrane features zwitterion clusters that are extremely hydrophilic allowing only water to pass through the membrane and rejecting hydrophobic substances and solids, thus limiting fouling. In one embodiment, a flocculant can be added to facilitate dewatering. In another embodiment, a filter aid can be added to the slurry to improve filtration performance. In some embodiments, the filter aid can be selected from a substance that is useful in the gasifier as a slagging additive including, without limitation, Ca(OH)₂, CaCO₃, a silica-containing mineral such as natural clay or diatomaceous earth. The overall result is that substantially all of the syngas impurities recovered during wet gas scrubbing is recycled to the gasifier and converted to additional syngas and slag without any waste being generated while essentially all of the water is ultimately reclaimed for re-use in the wet gas scrubbing section.

The dilute slurry stream has proven very challenging to concentrate using conventional centrifugation such as in a decanter centrifuge. Under conditions tested, high-speed laboratory swing bucket centrifugation was also not capable of breaking up the froth phase and a persistent soot containing froth remained on the surface even after extensive centrifugation. Direct filtration of the heavy phase or the sludge also proved to be very challenging. It was therefore very surprising that the high-speed disc stack centrifuge resulted in a substantially complete separation of the dilute slurry into a concentrated slurry with only clarified water emerging from the overflow port without any evidence of residual froth.

In certain embodiments, a surfactant that acts as a wetting agent is injected into the scrubber water being pumped to the Venturi Scrubber and Packed Bed Scrubber. The wetting agent decreases the surface tension between the water and soot particle surface to promote degassing and effective wetting such that soot is evenly suspended in the Venturi Scrubber sump rather than accumulating as a problematic froth phase. In some embodiments, provided herein are processes for eliminating the froth phase. This way, the froth phase cannot interfere with the efficient operation of wet gas scrubbing, such as by degrading pump performance and being carried over by the syngas.

In another embodiment, a wet electrostatic precipitator (“WESP”) is used downstream of the wet gas scrubbing flowsheet depicted in FIG. 3 to remove any remaining soot or aerosol contaminant remaining in the syngas. In some embodiments, the black water resulting from cleaning of the WESP is directed to the Settling Tank and reclaimed.

The present invention, thus generally described, will be understood more readily by reference to the following examples, which are provided by way of illustration and are not intended to be limiting of the present invention.

### Examples

Example 1A: Use of wetting agent in wet gas scrubbing operation. Six different surfactants, both anionic (Niaproof 08 and ColaWet DOSS 75) and non-ionic surfactants (DOW Ecosurf EH3, DOW Tergitol L61, Synperonic NCA 810, and Synperonic NCA 8300), were tested at varying concentrations (such as two or more of 0.25 vol %, 0.5 vol %, 0.75 vol %, 1 vol %, and 2% vol %). The samples were dosed with the prescribed amount of surfactant and then spun in a bench scale centrifuge. A number of surfactants did improve solids removal efficiency of the centrifuge provided that the correct dosage was used.

However, under the conditions tested, in the flowsheet of FIG. 3 featuring a jet ejector Venturi Scrubber, water dosed with surfactant resulted in additional foaming in the Venturi sump. This effect varied with the choice of the surfactant and concentration used. While in a gas cleaning layout that does not feature a jet venturi scrubber, surfactant addition may still have operational benefits, this example confirms the difficulty of effectively eliminating froth and foam resulting from the presence of hydrophobic solids with very small particle size together with water and gas in a Jet Venturi Scrubber that is designed to generate high shear and intimate surface contact between the gas and liquid phases.

Despite the above results, it was surprisingly observed that when black water without surfactant was used in a larger disc stack centrifuge skid, only a clear liquid layer and single heavy solids phase with no upper solids layer was obtained.

Example 1B: Characterization of soot in black water. The properties of the particulate soot processed in Examples 1 and 2 were further characterized to illustrate the impact of the particulate soot characteristics on the separation processes. Table 1 graphically illustrates and tabulates a typical particle size distribution of the soot indicating a volume average mean diameter of 11.7 micron and a number average mean diameter of 2.4 micron.

TABLE 1
Data for particle volume and size, illustration that 30%
of the total particle volume is less than 6.95 micron.

| | |
|---|---|
| Summary | Percentiles |

| Data | Value | % Tile | Size(um) |
|---|---|---|---|
| MV(um): | 11.69 | 10.00 | 3.58 |
| MN(um): | 2.410 | 20.00 | 5.21 |
| MA(um): | 7.15 | 30.00 | 6.95 |
| CS: | 8.39E−01 | 40.00 | 8.51 |
| SD: | 6.42 | 50.00 | 9.97 |
| Mz | 10.62 | 60.00 | 11.52 |
| σi: | 6.77 | 70.00 | 13.38 |
| Ski: | 0.2673 | 80.00 | 15.95 |
| Kg: | 1.140 | 90.00 | 20.55 |
| | | 95.00 | 26.22 |

Table 2 provides the proximate analysis of the collected soot particles confirming very high carbon content of 90% (w/w on dry basis) with lesser amounts of inorganic ash and volatile matter present.

TABLE 2
Data regarding Collected Soot Particles.

| Proximate | As Received | Moisture | Moisture & Ash | ASTM |
|---|---|---|---|---|
| Analysis | wt % | Free wt % | Free wt % | Method |
| Moisture | 0.77 | ***** | ***** | D7582 |
| Ash | 5.29 | 5.33 | ***** | D7582 |
| Volatile Matter | 4.60 | 4.64 | 4.90 | D7582 |
| Fixed Carbon | 89.34 | 90.03 | 95.10 | calculated |
| Total | 100.00 | 100.00 | 100.00 | |

Soot with high carbon content has a high surface tension (i.e. it is very hydrophobic and difficult to wet). The porosity of the soot particles of this example was 60% as measured with Hg porosimetry. The true solids skeletal density was measured to be 1.838 g/cm³ using ASTM D2638 test method, resulting in a particle or envelope density of 0.735 g/cm³ (i.e. 40% of 1.838 g/cm³).

Example 2: Use of flocculants to improve gravity separation of solids from black water. A flocculant promotes aggregation of small particles into larger particles (“flocs”) that increases the rate of settling or floating depending on whether the floc density is respectively greater or less than that of the liquid medium. Several commercial flocculants from Baker Hughes were evaluated with results depicted in FIG. 8. Flocculant was mixed with the samples and allowed to settle under gravity in the beakers. By comparing the flocculated samples with the control (far right), its clear that each chemical had some impact, both in terms of creating larger flocs and accelerating formation of a clarified water layer substantially free of solids. In all cases a significant fraction of solids was present in the froth phase indicating that the flocculants accelerated phase separation but did not have any significant impact on degassing the particles. FLW163 or Tretolite™ was eventually chosen for testing at the plant in accordance with the flowsheet depicted in FIG. 3. The impact of the flocculant was quantified using a Clarity Wedge or Water Turbidity Wedge, such as those available from www.chemworld.com, among others. A reading of 1 represents high particulate loading (no numbers visible on scale) while a reading of 46 represents low particulate loading and substantially clear water. The impact of the selected flocculant on the performance of the gravity Settling Tank is shown in Table 4. The black water being fed to the Settling Tank is completely turbid with a Clarity Wedge reading of 1 barely visible. During operation without flocculant, the Settling Tank produced a partially clarified water layer with a Clarity Wedge reading of 12 (significant turbidity still present and light black suspension to the naked eye). The flocculant was then dosed into the black water being pumped to the Settling Tank using an inline mixer. The clarified water turbidity reduced the Clarity Wedge reading improved to 42 or essentially clear with very minor turbidity. The dilute slurry was processed in the high-speed disc stack centrifuge depicted in the flowsheet of of FIG. 3 and resulted in complete separation and essentially fully clarified water emerging from the centrifuge with a Clarity Wedge reading of 46 (i.e. maximum clarity). This example demonstrated the effectiveness of a flocculant combined with the separation methods in accordance with the flowsheet of FIG. 3 to enable the separation of soot from black water to produce clarified water for re-used in wet gas scrubbing and dewatered soot to be fed to the gasifier to be converted into additional syngas.

TABLE 3
Impact of flocculant on quality of separation in Settling Tank

| | Black Water to | Clarified Layer from | Centrifuge Clarified |
|---|---|---|---|
| Flocculant | Settling Tank | Settling Tank | Water |
| No | 1 | 12 | 46 |
| Yes | 1 | 42 | 46 |

Example 3: Use of a disc stack centrifuge to separate the dilute slurry into clean water and concentrated slurry. The dilute slurry formed by the combination of the froth phase collected from the upper layer of the gravity separation device and the heavy phase collected from the bottom layer of the gravity separation device comprises soot, water and entrained air or gas. The hydrophobic nature of the soot in the froth phase makes it difficult to separate completely from the dilute slurry. A sample of this dilute slurry, when spun in a swing tube laboratory centrifuge, did not separate satisfactorily under the test conditions and did not produce a clarified water layer.

However, it was observed that this same dilute slurry when fed to the high-speed disc stack centrifuge produced two outlet streams with the overflow being clarified water essentially free of soot and a concentrated slurry collected from the underflow containing essentially all of the soot present in the dilute slurry as can be seen in FIG. 5. Without being bound by theory, it is contemplated that the interaction of the soot and entrained air within the froth with the closely spaced separating discs of the disc stack centrifuge, typically spaced about 1-2 mm apart, results in an effective degassing and wetting of the soot, thereby resulting in froth breakdown to heavy soot which is ejected as the concentrated slurry and release of entrapped gases that are vented from the centrifuge.

Without being bound by theory, after observing the surprising separation, it is contemplated that the small particle size, and the hydrophobic nature and high porosity of the solids results in significant entrapment of gas and solids creating a froth phase that is very persistent. It is further contemplated that the surprisingly effective degassing and separation of the froth in the high-speed disc stack centrifuge may be the result of intimate contact between the solids and the inclined discs that are very narrowly spaced about 1-2 mm apart.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” and the like shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, and the like. As a non-limiting example, each range discussed herein can be readily broken down into a lower third, middle third and upper third, and the like. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A method of removing impurities from black water associated with a gasifier, the method comprising:
adding a flocculant to the black water to create a black water and flocculant mixture;
settling the black water and flocculant mixture in a gravity settling device to separate the black water and flocculant mixture into clarified water, a froth phase, and a heavy phase, the froth phase comprising soot, water, and air or gas, and the heavy phase comprising soot and water;
drawing off the clarified water from the settled black water and flocculant mixture;
collecting a dilute slurry comprising the froth phase and the heavy phase; and
phase separating the dilute slurry in a high-speed centrifuge to provide additional clarified water and a concentrated slurry;
wherein the black water is obtained from wet gas scrubbing of syngas.

2. The method of claim 1, wherein the impurities comprise soot and gaseous contaminants.

3. The method of claim 2, wherein the gaseous contaminants include at least one of halogenated acids, ammonia, or volatile heavy metals.

4. The method of claim 1, further comprising recycling the clarified water for re-use as wet gas scrubbing water.

5. The method of claim 1, further comprising recycling the concentrated slurry to the gasifier producing the syngas.

6. The method of claim 5, wherein the concentrated slurry is recycled via a liquid injection nozzle.

7. The method of claim 5, further comprising mixing the concentrated slurry with solid feed material prior to recycling the concentrated slurry to the gasifier.

8. The method of claim 5, further comprising dewatering the concentrated slurry in at least one of a filter, a membrane, a centrifuge, or a dryer prior to recycling the concentrated slurry to the gasifier.

9. The method of claim 1, further comprising adding a surface-active agent to a wet gas scrubbing device.

10. The method of claim 1, wherein the clarified water produced by the high-speed centrifuge is substantially free of entrained gases, solids, and froth.

11. The method of claim 1, wherein wet gas scrubbing comprises scrubbing the syngas with one or more of a venturi scrubber, a column scrubber, and a supplementary solids separation device.

12. The method of claim 11, wherein the supplementary solids separation device is a wet electrostatic precipitator, the wet electrostatic precipitator to remove trace particulate impurities, wherein the resulting black water from the wet electrostatic precipitator is provided to the gravity settling device.

13. The method of claim 1, wherein the phase separating is performed in absence of a surfactant.

14. The method of claim 1, wherein the high-speed centrifuge is a disc stack centrifuge.

15. A method of removing particulate soot from a syngas of a gasifier, comprising:
dry separating, via a high-temperature cyclone, the particulate soot from the syngas; and
providing, via the high-temperature cyclone, the separated particulate soot to the gasifier to recycle the particulate soot.

16. The method of claim 15 further comprising contacting the separated syngas with a dry sorbent to neutralize halogenated acids in the separated syngas.

17. The method of claim 16 further comprising removing, via a dry particle collection device operating above a dewpoint of the separated syngas, spent dry sorbent.
